(19) United States
(12) Patent Application Publication
(10) Pub. No.: US 2016/0095369 A1
(43) Pub. Date: Apr. 7, 2016

(54) HEATED GLOVE AND METHOD OF MANUFACTURING

(71) Applicant: Gerbings, LLC., Stoneville, NC (US)

(72) Inventors: Cupid Roberts, Stoneville, NC (US); Kayla Stevens, Greensboro, NC (US)

(21) Appl. No.: 14/597,305

(22) Filed: Jan. 15, 2015

Related U.S. Application Data
(60) Provisional application No. 62/058,895, filed on Oct. 2, 2014.

(51) Int. Cl. A41D 19/015; H05B 3/34; A41D 19/04

(52) U.S. Cl. CPC A41D 19/01535; A41D 19/04; H05B 3/342; H05B 2203/036

(57) ABSTRACT

A heated glove comprising a glove body that includes a pair of body sections formed from a substrate material, with each body section having a substantially mirror image shape as the other body section. The glove body further includes elongate heating elements formed from a conductive material and attached to the outer surface of each body section with a couching stitch and in accordance with a predetermined layout pattern that is a substantially mirror image of the layout pattern of the other heating element. The pair of matching body sections are then attached together to form the glove body with the heating elements being substantially aligned in registration with each other.

### RELATED APPLICATIONS

The present Patent Application is a formalization of previously filed, co-pending U.S. Provisional Patent Application Ser. No. 62/058,895, filed Oct. 2, 2014 by the inventors named in the present Application. This Patent Application claims the benefit of the filing date of the cited Provisional Patent Application according to the statutes and rules governing provisional patent applications, particularly 35 U.S.C. §119(a)(i) and 37 C.F.R. §1.78(a)(4) and (a)(5). The specification and drawings of the Provisional Patent Application referenced above are specifically incorporated herein by reference as if set forth in their entirety.

### TECHNICAL FIELD

The present disclosure generally relates to heated or thermally regulated hand coverings, garments, clothing or other apparel items, or other hand held heated devices; and in particular, to hand coverings such as gloves, mittens and similar articles having active electrical heating elements for imparting warmth to a wearer.

### BACKGROUND OF THE INVENTION

Heated clothing has been available to provide supplemental warmth for protection against harsh weather conditions such as extreme cold. Such heated clothing has included, for example, jackets, coats, pants, boots, gloves, socks, hats, and other apparel items. In the past, replaceable chemical heating packets have been used to provide such apparel items with supplemental heating or warmth, which chemical heating packets that generally include chemically reactive materials that, when allowed to combine, create a reaction producing heat, and have been used inside pockets or inserted into gloves, boots or other items. Alternatively, heated apparel or clothing with heating pads integrated or inserted therein, such as disclosed in U.S. Patent Application Publication No. 2008/0223844, have been developed to utilize electric heating elements connected to a power source, such as a battery pack, for heating the clothing.

In some applications, such as a jacket or shirt or other large garment, the heating pads can be relatively large and thus their heating elements can be spread apart so that the heating provided thereby likewise is spread across the pad and thus is not localized, to try to avoid, as much as possible, the creation of hot spots that can cause overheating or even burning of the wearer's skin. For smaller apparel items such as gloves, however, regulating or ensuring desired spacing or placement of heating elements throughout the body of the gloves to avoid incidence of such potential hot spots or irregularities in the heat being provided, can be more of an issue.

Given the smaller size of gloves and similar smaller apparel items, and the desire or need to maintain flexibility of use and limit bulkiness thereof, it often has been necessary to specially manufacture the gloves to incorporate or integrate heating elements therein. For example, in the past, heated gloves have been manufactured by hand weaving a conductive wire heating element into patterned pieces of the glove, after which the patterned pieces have to be carefully sewn together. Such a process has, however, generally required substantially highly skilled workers to individually weave or insert a conductive wire heating element into the glove pieces and thereafter attach the pieces together to ensure accuracy in the placement of the heating element materials about the glove body. If the heating elements are placed too far apart or too close together, or if they are placed too close to the outer surface of the glove or too close to the inner surface thereof, the uniformity of the heating provided across and through the glove body can be significantly affected. Such a method of manufacturing heated gloves or other similar apparel items, further tends to limit production rates while raising re-work rates, and can significantly add to the cost of manufacture due to the requirement for highly skilled individuals to perform and/or oversee the manufacture of the gloves or other similar apparel items.

Accordingly, it can be seen that a need exists for heated gloves or other similar items of apparel or heated devices, as well as a method of manufacture thereof, that addresses the foregoing and other related and unrelated problems in the art.

### SUMMARY OF THE INVENTION

Briefly described, the present disclosure is directed to thermally regulated and/or heated apparel items and hand held heated devices and a method of manufacturing such thermally regulated and/or heated apparel items and hand held heated devices that is designed to provide enhanced accuracy of the placement of electrical or conductive heating elements throughout the body of a heated apparel item to substantially provide a desired uniformity of heating to the heated garment, without requiring highly skilled, manual manufacturing operations to produce such items/devices. In one particular embodiment, the present invention is directed to heated gloves, and a method of manufacturing such heated gloves with increased efficiency, accuracy and consistency, and which can utilize more automated sewing systems. It will, however, be understood by those skilled in the art that other, similar apparel items and/or hand held heated devices also can be manufactured utilizing the principles of the present invention, which is therefore not limited solely to the manufacture of heated gloves.

In one embodiment, the gloves can include a glove body formed from one or more patterned body pieces or sections of a flexible fabric or other textile carrier or substrate material. For example, each glove can be provided with a pair of corresponding or associated body sections that can be formed as substantially mirror image body sections, each including a first or main body portion and a series of protruding finger portions or sections. The main body and finger portions can be formed in different lengths and/or widths so as to match different wearer hand/finger sizes or lengths. A thumb portion also will be provided, which can be formed separately, or alternatively, in other embodiments, can be integrally formed with the body sections. A heating element generally will be applied along the main body portion and one or more of the finger portions of each body section. The thumb section or portion further can have a similar heating element material applied thereto.

The heating element can be formed from various conductive materials such as, but not limited to, silver, copper, zinc, stainless steel, carbon fiber, ni-chrome, gold, polymeric materials and/or other, similar conductive materials. The heating element can be applied as a wire, thread or filament, laid down and attached by a couching method of embroidery or sewing, wherein the heating element is applied to its body section as the body section is moved through the sewing area of a sewing/embroidery machine and is attached thereto, such as by application of a zigzag or over-locking stitch. Thus, a desired heating element application pattern can be programmed into an automated sewing/embroidery system and, as the heating element is laid down in its application pattern, it will be sewn or otherwise attached to the substrate of its body portion in accordance with the desired/programmed pattern. The heating element application pattern used can vary depending upon size, configuration, and the application for which the gloves, mittens or other apparel items are to be used, while further being designed to provide a desired spacing and thus a substantially consistent or uniform application of heating when a current is applied to the heating element.

Once the heating element/wire has been applied and attached in its desired or predetermined pattern to each body section, the body sections then can be overlaid or matched together and sewn or otherwise attached to form the glove body. The thumb sections similarly can be formed by application of a conductive wire or similar heating element to the substrate defining the thumb portion of the glove, after which the thumb portion can be rolled or folded into a substantially cylindrical configuration and attached to the glove body. By providing the application of the heating element or wire in a substantially matching or mirror image pattern, the ends of the heating element wires will be generally consistently aligned and brought substantially into registration with each other when the body pieces are matched together so as to facilitate the connection of the ends of the heating elements together, such as across a seam between body sections, and/or to an electrical connector or coupling. This connector or coupling in turn can be either tethered directly to a battery pack or other electrical power source for the glove or gloves, or can connect each glove in series to other garments for connection to a common power source or supply.

In addition, in other embodiments, the heated glove can comprise a liner configured to be inserted or otherwise incorporated into an outer shell or outer glove body. For example, the heated glove can comprise an inner layer or liner for ski gloves, work gloves or other, similar types of gloves formed from a more weather-resistant and/or further insulated material. In such an embodiment, the heated glove can be configured as a removable/replaceable liner or can be substantially integrated into or otherwise attached to an outer glove shell or body.

The present heated glove assembly also can be subjected to an impregnation or integration process by which a protective material, such as a liquid silicone or similar material, can be applied to the substrate of each body section. The protective material can be rolled or sprayed on to the substrate of each body section after the application of the heating elements thereto, with an additional backing or supporting substrate applied as needed. The composite body section structure thereafter subjected to curing such as by heating to a temperature and for a time sufficient to cause the liquid silicone or other protective material to cure. Thus, the heating element can be further protected from damage due to inadvertent exposure to water, sweat, etc., and the glove body further can be provided with an additional layer of insulation/protection for the wearer against direct exposure to the heating elements.

The present disclosure further includes one or more methods for making the heated glove assembly that includes obtaining a pair of matching body sections formed from a substrate material, and with each body section of the pair of matching body sections having a substantially mirror image shape as the other body section. The method also includes applying an elongate heating element formed from a conductive material to an outer surface of each body section with a couching stitch or method of embroidery or sewing, and in accordance with a predetermined layout pattern that forms a substantially mirror image with a predetermined layout pattern of the other heating element. The method further includes joining the pair of matching body sections to form a glove body having heating elements that are substantially aligned in registration with each other. In some embodiment the method can also include applying a layer of liquid insulation material to the outer surface of each body section, and then curing the insulation material to form a flexible insulation layer that encapsulates the heating elements.

Various objects, features and advantages of the present invention will become apparent to those skilled in the art upon a review of the following detail description, when taken in conjunction with the accompanying drawings.

### BRIEF DESCRIPTION OF THE DRAWINGS

FIG. 1 is a perspective view of one representative embodiment of a heated glove formed according to the principles of the present disclosure.

FIG. 2 schematically illustrates a layout or pattern for the application of the conductive heating element to the body sections of a heated glove, in accordance with another representative embodiment.

FIG. 3 is a cross-sectional perspective view of a finger portion during the manufacture of one embodiment of the heated glove, as viewed from expanded region A-A of FIG. 2.

FIG. 4 is a perspective view of the outer side seam and lower edge of one embodiment of the assembled heated glove, as viewed from expanded region C-C of FIG. 1.

FIGS. 5A-5B are perspective views of the inner side seam and lower edge of additional embodiments of the assembled heated glove, as viewed from expanded region D-D of FIG. 1.

FIG. 6 is a perspective view of the seam between a separately-manufactured thumb section and two body sections of an assembled heating glove, in accordance with another representative embodiment.

FIG. 7 is a schematic cross-sectional view of the proximal region of a finger sheave of one embodiment of an assembled heating glove, as viewed from section line B-B of FIG. 1.

FIG. 8 is a schematic cross-sectional view of proximal region of a finger sheave of another embodiment of an assembled heating glove.

FIG. 9 is a perspective view that schematically illustrates the application of a protective insulating layer and a support layer to a carrier substrate having a heating element attached thereto, in accordance with another representative embodiment.

Those skilled in the art will appreciate and understand that, according to common practice, the various features of the drawings discussed below are not necessarily drawn to scale, and that the dimensions of various features and elements of the drawings may be expanded or reduced to more clearly illustrate the embodiments of the present invention described herein.

### DETAILED DESCRIPTION OF THE INVENTION

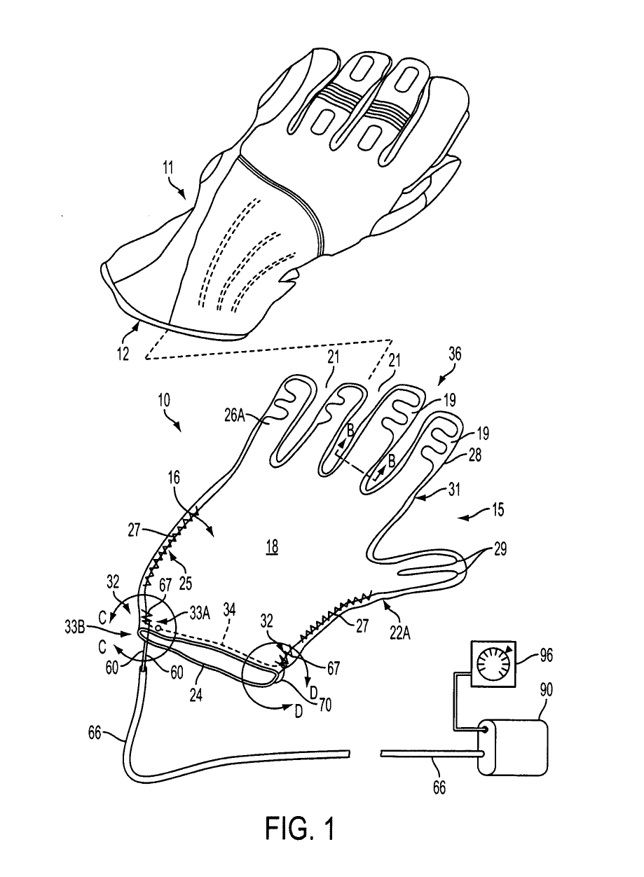

Referring now to the drawings in which like numerals indicate like parts throughout the several views, the present invention is generally directed to thermally regulated and/or heated garments, clothing or other items of apparel, as well as hand-held heating devices, and a method of manufacture of such heated apparel items or other heated devices that enables the manufacture of such heated apparel items or heated devices using substantially automated processes and equipment, and which is designed to provide enhanced accuracy and consistency in the placement and application of conductive heating element materials to the apparel item or other heated device to provide a substantially uniform application of heat thereby. FIGS. 1-9 illustrate various example embodiments of a heated apparel item, shown as a glove 10. However, it will be understood that the principles of the present invention are not be restricted solely for use in gloves, mittens or other, similar heated hand coverings or articles, and the manufacture thereof, but rather can be used for the manufacture of various types of heated or thermally regulated items of apparel and/or other types of heated devices or articles.

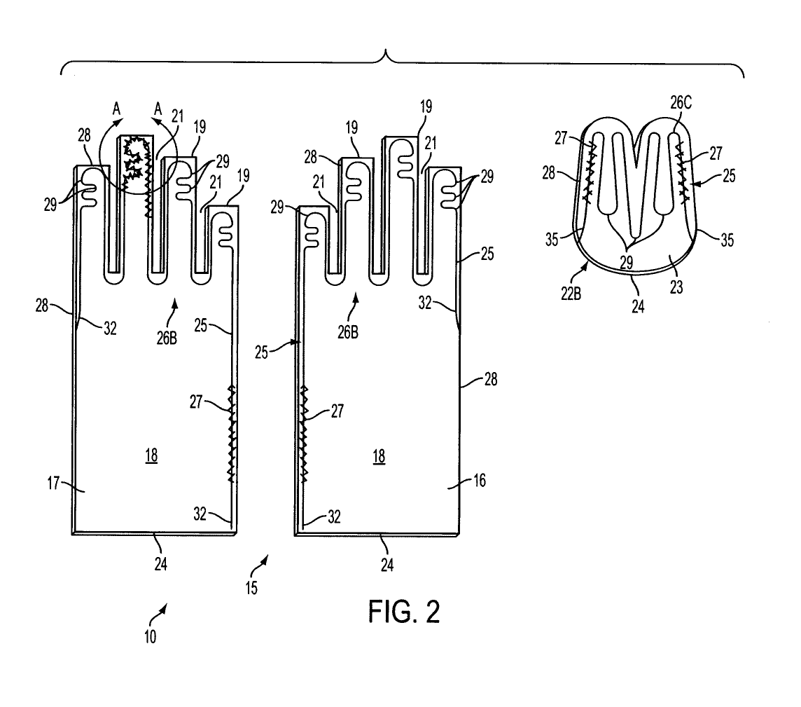

In one embodiment of the heated apparel item illustrated in FIGS. 1-2, the glove 10 can comprise an inner liner or insert that is configured to be placed, received or otherwise integrated within an outer glove or shell 11. For example, the heated glove 10 can be provided as a liner for use with ski gloves or mittens, work gloves, or other, similar items. The outer glove or shell 11 can be formed from a water repellant or resistant and/or tear resistant material with an interior portion or pocket 12 defined therein, in which the heated glove 10 can be received. The outer glove shell/body 11 also can include a series of layers or plies and the heated glove 10 can be configured as a replaceable or removable liner received within and removable from the outer glove shell/body 11, thus enabling its use with a variety of different outer glove shells/bodies. Alternatively, the glove 10 can be sewn or otherwise integrated into the outer glove shell/body, such as by being sewn between inner and outer layers or plies of the outer glove shell/body.

As illustrated in FIG. 2, in one embodiment, the heated glove 10 formed according to the principles of the present invention can include a body 15 formed from two corresponding or matching body sections, shown as first and second body sections 16, 17. Each body section 16 and 17 in each pair of body sections can be formed with a substantially mirror image of the shape and construction of its opposing or corresponding body section, for consistency of manufacture. Each body section 16, 17 will further include a palm portion 18 configured to substantially cover the palm and/or wrist portions of a wearer, and a series of finger portions 19 that project forwardly from the palm portion 18. The palm portion 18 and each of the finger portions 19 generally can be formed in various sizes, lengths and/or configurations as needed to form different size gloves, with each finger portion also being separated by gaps 21, as indicated in FIGS. 1-2. A thumb portion generally will be provided with the body 15 of each glove 10. In some embodiments the thumb portion 22A could be formed with or as an integrated part of the body sections 16, 17 of the glove body 15, as indicated in FIG. 1. Alternatively, as shown in FIG. 2, the thumb portion 22B of the glove can be formed as a separate patterned thumb part or piece 23 of a desired size in accordance with the body sections 16, 17, and to which it will be attached upon assembly of the glove.

The body sections 16 and 17 (and the separate thumb section 23, if applicable) of each glove body 15 generally comprise a carrier or substrate 24 that can be made of a variety of flexible and thermally stable woven or non-woven fabric or other textile materials. Such materials for the carrier or substrate 24 generally will be selected so as to provide sufficient support and flexibility, as well as allowing a desired amount of heat transfer and diffusion therethrough. Examples of substrate materials include woven and non-woven natural and/or synthetic tricot fabric materials, such as cotton and/or various cotton fiber blends, synthetic or plastic material blends, as well as other synthetic or composite materials, including heavy paper. The carrier or substrate 24 generally will be selected to provide a level of insulating properties sufficient to protect the wearer from direct contact with the heating elements, while still enabling a desired or predetermined level of heat transfer and conduction/diffusion therethrough to provide a target heating output or warmth to the wearer. Moreover, in some aspects the carrier or substrate 24 can be permeable, such as may be provided by a permeable textile or fabric, with a sufficient permeability or porosity to allow for a liquid protectant or insulation material to at least partially penetrate into the thickness of the substrate 24, and/or to even fully saturate or impregnate the material of the substrate. In other aspects the carrier or substrate 24 can be substantially impermeable so that an applied liquid protectant material may adhere to the outer surface of the substrate 24 without penetrating below or through the surface thereof.

As indicated in FIGS. 1-2, heating elements 25 will be applied to one or both of the first and second body sections 16, 17 (and to the separate thumb section 23, if applicable) of each glove body 15. The heating elements will be applied and affixed to the body sections in a predetermined or programmed heating element application pattern, such as the application pattern 26A shown in FIG. 1 or application patterns 26B, 26C illustrated in FIG. 2. The patterns of the heating elements 25 applied to each pair of matched first and second body sections likewise will be formed with a substantially mirrored or matching configuration.

In addition, the heating elements 25 will be attached or secured to the carrier or substrate 24 of the body sections using an automated couching method of embroidery or sewing, including, but not limited to, application of a series of zigzag or overlocking couching stitches 27, whereby the overlying thread secures the heating element to the substrate 24 in its desired/predetermined lay-out/lay-down pattern. Moreover, the heating elements 25 also can be attached or secured to the outer surface of the carrier or substrate 24, opposite a side of the substrate 24 that will come into contact with the skin of the user or wearer of the glove 10. This placement on the outer surface of the substrate 24 can ensure that the heating elements 25 do not come into direct contact with the skin of the user, and instead provides for the heat generated by the heating elements 25 to be conducted through and to some extent diffused by the thickness of the carrier or substrate 24 prior to reaching the skin of the user.

Using the couching method of attachment, the heating elements 25 can be laid down or otherwise applied in an overlying relationship onto outer surface of the substrate 24 of the first and second body sections 16, 17 according to the predetermined or programmed application pattern 26A, 26B, for example, being applied adjacent to the peripheral or side edges 28 of the palm portions 18 and finger portions 19 of each body section 16, 17 (FIGS. 1-2). In addition, for the embodiments of the glove 10 have a separately formed thumb section, the heating element 25 can also be laid down or otherwise applied in an overlying relationship onto the outer surface of the substrate 24 of the thumb section according to a predetermined or programmed heating element application pattern 26C that will be configured to interface or register with the heating element application pattern 26B of the body sections 16, 17 upon assembly of the glove 10. After attachment of the heating elements 25 via an automated sewing station/equipment, the body sections of the glove can subsequently be attached or sewn together so that the mirrored heating element application patterns 26A, 26B on the body sections 16, 17 become substantially aligned and/or registered with each other upon assembly of the body 15.

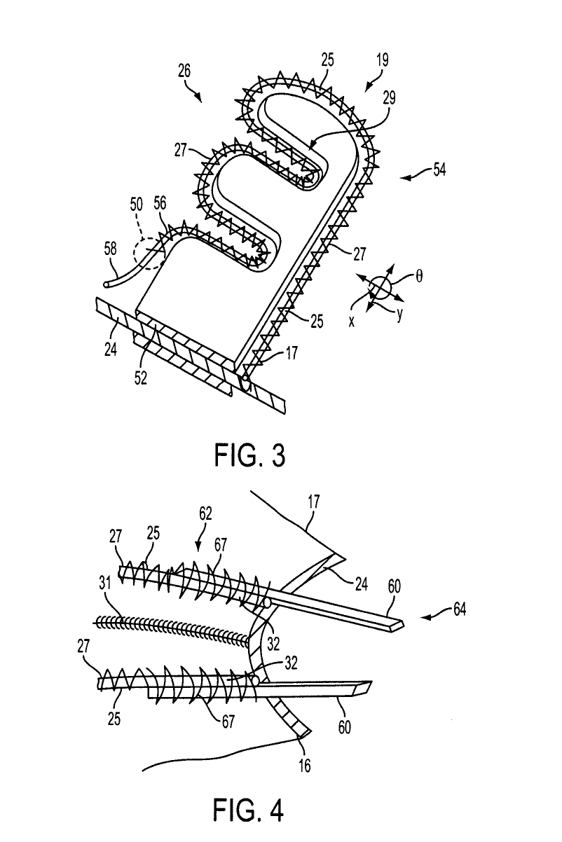

FIG. 3 provides an expanded view of region A-A of FIG. 2 of one of the finger portions 19 of a body section 17, during manufacture of the glove, wherein the carrier or substrate 24 of the body section 17 generally will be moved in lateral, longitudinal and/or angular directions (i.e., x-y-θ directions) through a sewing area 50 and underneath the one or more needles (not shown for purposes of clarity, but known to one of skill in the art) of a sewing station.

For example, in one aspect each body section can be moved under the control of a movable work table (not shown) to which a body section can be secured by material clamp plate 52 programmed to move the body section along the table surface into engagement with one or more sewing needles of a sewing head in accordance with the selected/desired heating element application pattern 26B for the glove.

As described above, in one aspect the heating element 25 will be sewn to the carrier or substrate 24 using a zigzag or overlock style couching stitch 27 using a couching type embroidery/sewing method, wherein the conductive wire or filament of the heating element 25 will be naturally drawn or fed to the sewing area 50 and laid down or located onto the substrate 24 through the lateral, longitudinal, and/or angular motion of the body section under control of the clamp plate 52 following the programmed application pattern, as the heating element is sewn to the substrate. Generally, the attachment of portions 56 of the heating element 25 against the substrate of the body section and movement thereof can provide a tensile force sufficient to draw additional unattached portions or lengths 58 of the heating element 25 into the sewing area 50 and onto the substrate. As a result, the controlled movement of the body section through the sewing area 50 enables for the substantially precise feeding and positioning or laying out of the heating element 25 upon the surface of the carrier or substrate 24 in accordance with a desired/programmed digital application pattern simultaneously with the sewing of the heating element 25 to the body section. The heating element materials, i.e., the conductive wires or threads, further can be fed under control of a driven feed roll to ensure consistency and accuracy of placement and application of the heating element materials without undue tension placed thereon. As may be appreciated, such sewing operations can be accomplished with substantially automated equipment and without the required use of highly skilled/trained workers.

In some embodiments it may be desirable for the application patterns 26B and 26C to extend proximate or adjacent to the peripheral edges 28 of the palm portions 18 and to the peripheral edges 28 of the finger portions 19 of the body sections 16, 17. It may also be desirable for the heating element application patterns 26B and 26C to also include various bends, and/or transverse extending segments 29 in the distal regions of the finger portions 19 and thumb portion 22B. This can be advantageous by allowing for application patterns 26B and 26C that can provide the heated glove 10 with improved heat generation characteristics, along one or more portions of the glove body including enhances control and/or consistence of heating such as, for example, a substantial uniformity of low-level heat generation in the palm portion 18 combined with a substantial uniformity of increased or higher levels of heat generation at or around the distal regions of the finger portions 19 and thumb portion 22B.

The couching method of applying and securing the heating elements to the body sections generally illustrated in FIG. 3 further can utilize one or more clamp plates 52 having a shape that closely matches the intended heating element application pattern 26B. For instance, with the shape of the clamp plate can substantially conform to the shape of the body section so as to act as a guide for the sewing needle(s) as the heating element 25 is stitched to the substrate material 24, to help substantially reduce or eliminate distortions in the substrate 24 caused by the forces, such as tensile or pulling forces acting on the substrate and/or heating element, developed by or resulting from the attachment/sewing of the heating element material to the carrier or substrate using the couching method described above, particularly when the heating element is attached to the substrate adjacent to the peripheral edges 28, of the body sections or across the thumb or smaller areas, such as the finger portions 19, of the body section. Thus, in one aspect the improved support, quality, and accuracy provided by the automated couching method can result in increased options for consistently locating and attaching the heating element materials along on the substrate of each body section. Moreover, it will be understood that other, varying patterns and/or additional applications of heating elements also can be provided.

The heating element 25 of FIGS. 1-3 generally can comprise a coated or uncoated conductive wire, thread, filament or other suitable conductive strand material that can be applied in a heating element application pattern. Appropriate conductive wires, filaments, threads, fibers or other materials may include copper, zinc, anti-chrome, silver, nickel, alloys thereof, as well as various synthetic or polymeric materials having a selective resistance per inch suitable for generating a desired heat output. By way of example, the conductive wire, filament, threads, fibrous or strand material can have a balanced resistance per inch thereof to provide a target heat output of between approximately 5-100 watts per inch (W/in). The resistance of the heating element materials further can be selected to provide the desired target heat output using an application of reduced or maximum operative voltage that may range from about 1.5 volts to about 28-30 volts and/or from a resulting current application ranging from about 5 mA to about 100 mA. Other higher or lower heat output levels and/or operating voltage/current levels also can be used depending upon the application for which the heated glove is to be used.

Higher thermal energy within smaller or more isolated areas of the glove body can yield an increase in the rate of heat transfer per unit area, also referred to as thermal flux, to a wearer's body in these areas. This is due, in part, to the thermal flux being proportional to the difference in thermal energy between two conductive bodies, with the thermal flux being greater when a higher thermal energy gradient is maintained, regardless of power consumption of the heating element. Thus, a series of programmed heating element application patterns by which the heating elements 25 are applied to the first and second body sections 16, 17 and/or the thumb section 23 of the glove body 15, respectively, generally can be digitally created and stored in a computer memory and, as needed, can be selected to balance or provide desired heating levels to areas of the wearer's hand and/or for manufacture of different types of heated gloves for different environments or applications. For example, as shown by the application patterns illustrated in FIG. 2, in one aspect the heating element can be configured to provide or concentrate/focus the heating output substantially along the extremities of the wearer's hand, such as along the distal regions of the finger portions 19 thereof. Similarly, the thumb portion 22B generally will also be provided with a heating element in a desired application pattern selected to provide substantial uniformity or consistency of heating therealong.

In addition, the length and resistivity of the conductive materials conductive heating elements 25 also can be selected to match a desired thermal output when used with a suitable power source, thereby optimizing performance of the heated glove. Various heating element characteristics can be utilized to optimize the resistivity of the heating element to match a preferred power supply voltage such as the number of heating elements, the lengths of heating elements, and the conductivity of heating elements. Moreover, during attachment of the heating elements onto the carrier or substrate, the application patterns of the heating elements can be customized to optimize the overall resistance of the heating element array. These patterns then can be pre-programmed into a sewing machine that attaches the heating elements to the body sections 16 and/or the thumb section, as discussed above.

Through the use of the application method(s) described above, one or both body sections 16, 17 can be provided with the conductive heating element 25 extending therealong in the programmed or desired heating element application pattern. By forming associated/corresponding pairs of first and second body sections 16, 17 as substantially mirror images of one another in both shape and construction (e.g., with mirroring heating element application patterns 26A, 26B), the body sections 16, 17 can then be easily and substantially accurately aligned and attached together, such as by sewing along their peripheral edges 28. In addition, upon the attachment of the body sections 16, 17 to each other, the heating elements 25 that have been pre-applied to the body sections 16, 17 can likewise become substantially aligned with each other, and with the ends of the heating elements 25 generally being brought into alignment or registration with each other, as discussed in more detail below.

In embodiments wherein the thumb portion is formed as a separate part or piece from the body sections of the glove body 15 (e.g., as indicated in FIG. 2), the thumb section 23 generally can be formed in a size corresponding to a matching glove body, and will be rolled or folded into a substantially cylindrical configuration and sewn about a desired portion thereof, thus leaving an opening for the wearer's thumb, after which the enclosed thumb 23 section will be sewn or otherwise attached to the composite or joined body sections 16, 17. Alternatively, the thumb section 23 can be attached and its edges sewn during the same operation as used for attaching or sewing the body sections together to form the finished glove body 15.

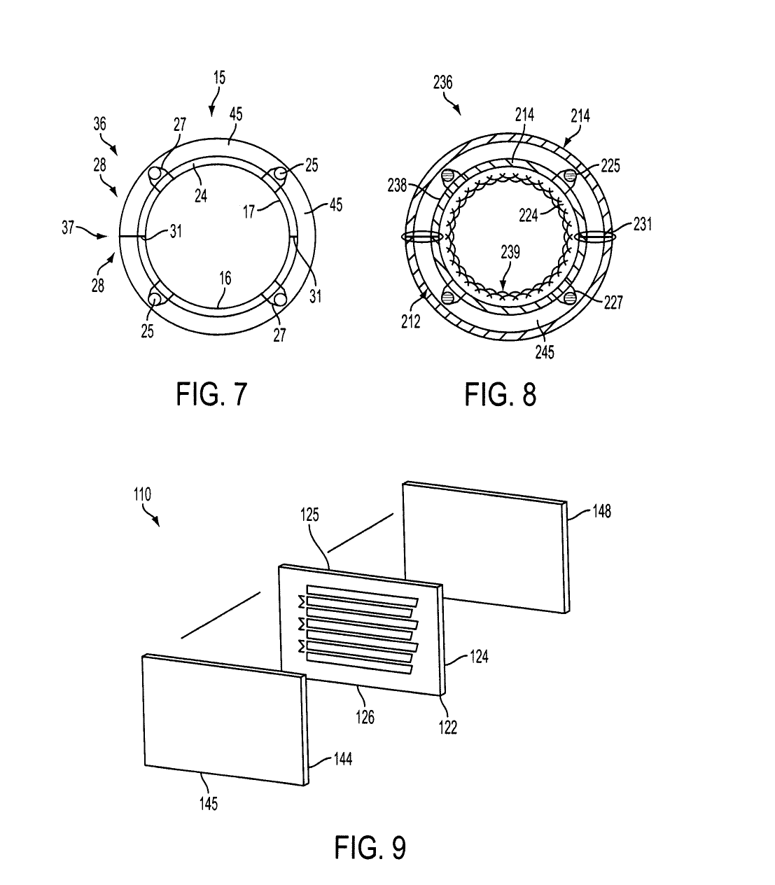

FIG. 7 is a cross-sectional view through the proximal region of a finger sheath 36 after assembly of the body sections 16, 17 into the glove body 15, as may be viewed through section line B-B of FIG. 1. The finger sheath 36 is configured to receive one or more of a plurality of a wearer's fingers, and conforms to the generally cylindrical shape of a wearer's finger. As indicated in the drawing, the finger portions 19 of the lower and upper body sections 16, 17 can be attached at seams 31, with the conductive heating elements 25 extending parallel or adjacent to the peripheral edges 28 or seams 31 in the proximal regions of the finger portions 19. In one aspect the conductive heating elements 25 can also be sufficiently spaced from the peripheral edges 28 or seams 31 and from each other so as to become substantially uniformly spaced or distributed around the circumference of the glove finger upon assembly of the glove body 15. This configuration can be used to surround at least the proximal portion of a finger of a user with a substantially uniform blanket of heat when in use.

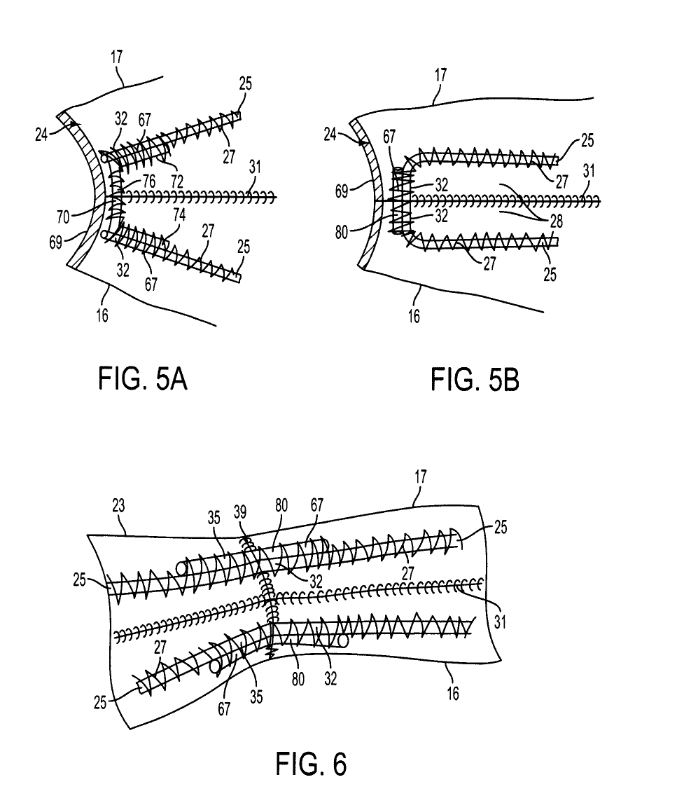

The heated glove system 10 of FIG. 1 can include, in addition to the conductive heating elements 25 attached to the various body sections 16, 17, additional electrical components such as connectors/terminals 60 for connecting the conductive heating element of the glove to a power transmission line or conduit 66, an electrical power supply 90 (which can be regulated by a controller 96) that provides the electrical power (current/voltage) which in turn connects to for activating the heating elements 25. Furthermore, the ends 32 of the conductive wires, threads, filaments or fibers of the heating element 25 generally can be aligned and/or registered together to facilitate their being coupled, in one aspect, to a terminal or series of terminals 60 for connection to the electrical power supply 90 (expanded view C-C and FIG. 4). In another aspect, the ends 32 of the heating elements 25 opposite the terminals 60 can be aligned and/or registered together to electrically connect the heating element application patterns in each body section (see expanded view D-D FIG. 5) to form a completed loop circuit that passes forward and back around the periphery of the heated glove 10.

Alternatively, the ends of heating elements opposite the terminal(s) can be extended back across the width of the glove, such as with the heating element segment 34, to form a separate circuit and/or connection for each of the heating element application patterns 26A. In yet another aspect (FIG. 2), the ends 32 of the heating elements 25 can be aligned and/or registered together to electrically connect the heating element application patterns 26B in each body section 16, 17 with the heating element application patterns 26C in the thumb section 23 to form a complete loop circuit (FIG. 6). It is to be appreciated that additional variations in the heating element application patterns and connection configurations are possible for creating a wide variety of heating element circuit designs, and are also considered to fall within the scope of the present disclosure.

Referring first to FIGS. 1 and 4, in some embodiments the ends 32 of the heating element of the body sections 25 can be electrically coupled through one or more terminals 60 comprising flat braided copper conductors for connection to the power source 90 are suitable for use as terminals 60. Generally, a heating element 25 is first stitched into or onto the carrier or substrate 24 using the couching method of application described above, such as with a zigzag or overlock couching stitches 27, and generally with a non-conductive thread that has been selected for its strength and durability. One end 62 of each terminal 60 can then be placed in contact with the ends 32 of the heating elements 25 at input and output locations 33A/33B, and a second area of stitching 67, including zigzag or overlock couching stitches, can be applied to secure the terminals 60 to the heating elements 25. It can be preferable to use a conductive or semi-conductive yarn or thread 67 to stitch the terminal 60 to the heating element 25 and the carrier or substrate 24 to improve the connection between the two conductive elements. The opposite ends 64 of the terminals 60 may be electrically connected to a conductive wire/power line or electrical conduit 66 (FIG. 1), either directly or via an electrical plug-in connection, that leads to power source 90, such as a battery pack, or other similar power source.

In one embodiment the power source, such as a battery pack, can be integrated or built into the glove body itself, and the ends of the conductive heating element can be directly connected to the integrated power source. In other embodiments, such as shown in FIG. 1, the power source 90 can be remote from the heated glove 10 and also can be linked to a controller device 96 for the regulation and control of the power supplied to each glove body 15 through the electrical conduit 66 to the heating element as needed to adjust or regulate the amount of heat or warmth provided thereby. In one embodiment, the glove 10 also may be electrically connected via the electrical conduit 66 to additional thermally regulated or heated garments, or other apparel items or heated devices, with the heated glove and such additional heated garments connected in series so as to define or form a system for providing heat to various parts of a user's body.

The heated glove 10 further can include a sensor that provides feedback to the controller device 96 for regulation of the electrical power that is provided to the heating elements 25. The sensor can include a thermocouple, thermistor and the like that can measure the temperature at predetermined locations within the glove body or the voltage level or resistance of the conductive heating element 25, or a temperature sensor. In one aspect, the sensor can be integrated directly into or along the heating element application pattern 26A formed by the heating element 25.

FIG. 5A is a perspective view of a side seam 31 and lower edge/wrist portion 69 of one embodiment of the assembled heated glove 10, as viewed from expanded region D-D of FIG. 1. In this configuration the ends 32 of the heating elements 25 can be electrically coupled together to connect the heating element wires in each body section and complete a single loop circuit that passes forward and back around the periphery of the heated glove 10. The connection can be provided by a jumper or bridge connection 70 that extends across the seam 31 between a lower body section 16 and an upper body section 17. In one example embodiment, the jumper or bridge connector 70 can also be a bare flat braded copper conductor, attached using a couching sewing/embroidery method such as described above. The opposite ends 72, 74 of the jumper 70 can then be placed in contact with the ends 32 of the heating elements 25 and the second stitching 67 applied to secure the ends 72, 74 of the jumper 70 to the ends 32 of the heating elements. It may also be preferable to use a conductive or semi-conductive yarn or thread 67 to bridge/connect the jumper 70 to the heating element 25 and the carrier or substrate 24′, for example, using zigzag or overlock couching style stitches 27 to secure the jumper 70 to the substrate, with a center section or portion 78 crossing over the seam 31 between the body sections 16, 17.

FIG. 5B is a perspective view of another embodiment of the assembled heated glove 10, as viewed from expanded region D-D of FIG. 1, and in which the ends 32 of the heating elements 25 are bent/curved toward the peripheral edges of the body sections so that the ends can be brought into end-to-end registration with each other at or along the seam 31 upon assembly of the body sections to form the glove body. Since the width of the seam 31 can create varying size gaps that can prevent the abutting end-to-end contact of the heating elements 25, the electrical connection between the ends of the heating elements can further be established by application of a jumper or bridge connector 80 that extends across the seam 31 between the lower body section 16 and the upper body section 17 to ensure formation/completion of the loop circuit around the periphery of the heated glove 10. As above, the jumper 80 can be secured to the ends of the heating elements using a series of zigzag or overlock couching style stitches 27 of a conductive or semi-conductive yarn or thread 67 to attach the jumper 80 in electrically conductive contact to the heating elements and to affix them to the carrier or substrate.

As depicted in FIGS. 2 and 6, a similar methodology can be applied in embodiments of the heated glove 10 in which the thumb portion is formed as a separate piece are attached and sewn to the edges of the joined body sections 16, 17 along a thumb seam 39. Upon assembly of the thumb section to the joined body sections, the ends 35 of the heating element 25 in the thumb section can be placed into end-to-end registration and contact with a portion of one or both of the heating elements 25 of the joined body sections across a side seam 39. The width of the seam 39 can define a gap that can affect the abutting end-to-end contact between the heating elements 25 of the thumb portion 22B and the body, and thus the electrical connection therebetween additionally can be established by jumpers or bridge connectors 80 that extend across the seam 39 as indicated in FIG. 6. As above, the jumpers 80 can be secured to the ends 32 of the heating elements 25 using a series of zigzag or overlock couching style stitches 27 of a conductive or semi-conductive yarn or thread 67 to attach portions of the jumpers in electrically conductive contact to each of the heating elements 25, and to also affix them to the the carrier or substrate 24.

In addition to the above-described aspects of the present disclosure, it will be understood that the heated glove 10 and its the method of manufacture can allow for the heating elements 25 to be substantially accurately and consistently attached to the body sections and thumb sections while still enabling the use and/or selection of a wide variety of programmable heating element application patterns. This can include application patterns with the heating elements extending both along the peripheral edges of the carrier or substrate, as well as across the expanse of the carrier or substrate, including transversely back and forth across narrow sections of the substrate such as finger sections, and which are configured to avoid the incidence of hot spots and irregularities in the heat being provided to the wearer of the heat glove. The ends of the heating elements of the glove body sections also can be substantially accurately and consistently positioned at termination or connection locations that are different than those described in the representative embodiments above, and that may be configured for connection with a variety of terminals, jumpers, sensors or other conductive elements. As a result, the heated gloves and other similar heated devices or articles can be readily manufactured and assembled using substantially standardized sections or parts that can be matched and produced as needed, including enabling an array of different styles and thermal outputs provided thereby.

According to another aspect of the present invention, an additional level of protection for the heating elements 25 that have been embroidered onto the outer surfaces of the body sections 16, 17 and assembled to form the body 15 of the glove 10 also can be provided to protect the heating elements 25 against being cut, shorted, broken, exposed to moisture, oxidation, electrical discharges, electroplating, harsh chemicals, or otherwise damaged by environmental hazards, even when the glove 10 is used as a liner or insert that is received within an outer glove or shell 11 (FIG. 1). For example, the body sections can be laminated or impregnated with a resilient and flexible protective material that protects the heating elements 25 and other components of the heated item of apparel from damage as a result of abrasion, puncture, kinking, and other environmental hazards. For example, protective materials including various polymers, plastics, a liquid silicone, or the like, that cover and/or encapsulate the heating element and at least a portion of the surface of the substrate to an extent sufficient to seal out moisture from the fabricated structures, to render the heating elements substantially more resistant to mechanical impact and contact hazards can be applied. It will also be understood, moreover, that while this aspect of the invention is described herein in the context of gloves and their manufacture, the invention is not limited solely to the manufacture of gloves.

FIG. 9 illustrates one embodiment of a method of forming a coated or impregnated heating apparel item 110, such as for forming a glove body, here shown as including a carrier or substrate 124 that, in one aspect, can be formed from a fabric 122. A heating element 125, in the form of conductive yarns, filaments, fibers, wires or similar flexible heating elements can be embroidered or stitched onto the outer surface of the carrier or substrate 124 using automated embroidery/sewing machinery and a couching method of application, as discussed above. In this example, the conductive heating element 125 can be applied in a zigzag and/or multi-row application pattern 126, such that areas of increased thermal density can be created along the substrate, and attached by a series of couching stitches as discussed above. However, it will be understood that other application patterns, including but not limited to a looped heating element application pattern similar to those depicted in FIGS. 1-2 above, may also be attached to the carrier or substrate 124. Upon application or attachment of the conductive heating element 125, the substrate 124 can then be coated and/or the substrate 124 impregnated with a liquid protectant material 144 that encapsulates and covers the application pattern 126 so as to provide a layer of physical protection and insulation for the conductive heating element 125. The liquid protectant material 144 can subsequently be cured into a flexible insulation/protective layer 145.

Also shown in FIG. 9, in some embodiments an optional stabilizer or support layer 148, such as a woven or non-woven pad or substrate/backing, can also be applied to the substrate 124. In one aspect the support layer 148 can be applied to the inside surface of the substrate, opposite the heating element application pattern 126, and either before or after application of the liquid protectant material 144 that covers the application pattern 126. In other aspects the support layer 148 can be applied to the outside surface of the substrate after the application and curing of the liquid protectant material 144 to form the insulation layer 145, so that the cured insulation layer 145 is effectively sandwiched between the carrier or substrate 124 and the support layer 148.

In a preferred embodiment the protective material 144 can be a liquid silicone material that may be mechanically applied onto the outer surface of the substrate 124, such as by spraying, rolling, calendaring or other, similar method. Liquid silicones maintain full elasticity over a wide temperature range, and resist aging, ozone deterioration, harsh chemicals, and other hazards. In addition, liquid silicones provide good electrical insulation for the heating elements attached to the substrate. Moreover, liquid silicones generally can be less readily deteriorated by electromagnetic field exposure and radiation exposure than liquid plastics. In addition, unlike liquid plastics, liquid silicones typically have a high biological inertness, are odorless, tasteless, do not support bacterial growth, and will not stain or corrode other materials. After application to the substrate 124, in one embodiment the liquid silicone material may be cured into the insulation/protective layer 145 by heating at about 140°-160° F. for 2 hours.

In another representative embodiment, the substrate 124 with attached heating elements 125 can be impregnated with a liquid silicone using a low pressure liquid injection molding impregnation technique. Liquid silicones have relatively low viscosities when compared with liquid plastics. Typically, viscosities for liquid silicones at the point of injection range from 500 to 1,000 Pa-s, while liquid plastic viscosities are normally between 5,000 to 10,000 Pa-s. This allows for much lower injection pressures during the injection impregnation process. The inner glove layer, which in one aspect can be the fabric carrier or substrate 124 for the heating elements 125, is placed in the cavity of an industry standard silicon injection molding and the injection molding machine is then closed. Liquid silicone and a catalyst that may comprise a platinum curing agent are transferred into the injection molding machine via a pneumatic pumping mechanism. Various mixing ratios for the liquid silicone and the catalyst may be used; for example, a mixing ratio of almost 1:1 can be used, with the liquid silicone and the catalyst mixed via a static mixing device in the injection molding machine and injected under pressure into the cavity containing the substrate.

Regulation of the injection pressure typically is required prior to introduction of the mixed material into an injection unit of the injection molding machine. Injection pressures may range between 100 psi and 1200 psi depending on process parameters such as the type of liquid silicone being used, the volume of liquid silicone, extrusion temperature, and the like. In preferred embodiments, injection pressures range between 100 psi and 500 psi, which has been found to prevent over-compression. The mixed material is fed into an inlet port on a barrel of the injection unit. The injection unit barrel typically is water cooled to prevent the friction and pressure from curing the mixed material prematurely within the barrel. Injection of the mixed material into the cavity is accomplished by utilizing a check valve at the end of a screw that is cylindrically wrapped around the barrel of the injection unit. Once in the cavity, the pressurized mixed material will then permeate the material of the carrier or substrate 124 that supports the heating elements 125. It is preferable that the injection molding machine also include a water-cooled shut-off nozzle to prevent the mixed material from back-flowing and prematurely catalyzing due to friction and pressure.

The mixed material is then cured in the cavity of the injection molding machine with the help of the catalyst, thereby impregnating the substrate with silicone. Cavity temperatures during the curing process typically range between 300° F. and 600° F. and cure time typically ranges between 30 seconds and 5 minutes depending on process parameters. The cavity is then opened and the silicon impregnated substrate, which will become an inner glove layer, is removed.

With reference again to the cross-sectional view of the finger sheath 36 provided in FIG.

7, in one embodiment the assembled body 15 further can be provided with a protective insulation layer 45 that has been applied to the substrate layer 24 to envelop and protect the elongated heating elements 25 that have been attached to the outer surfaces thereof, such as with the automated couching method of embroidery described above. Furthermore, and depending on the method of construction, the insulation layer 45 may be applied to the body sections prior to the sections being stitched together to form the assembled body 15, in which case the seam 37 that joins the body sections can also extend through the insulation layer 45. In the alternative, the protective insulation layer 45 may also be applied to body 15 after assembly and attachment of its first and second body sections 16, 17, in which case the seam 31 that joins the first and second body sections 16, 17 also can be covered and sealed by the insulation layer 45.

In yet another embodiment, illustrated in the cross-sectional view of a finger sheath 236 shown in FIG. 8, the heated glove can include a substrate 224 that has been covered or impregnated with a flexible insulation layer 245 to form an inner glove layer 121, and which inner glove layer 121 is then surrounded or encased by an outer glove layer 214. The substrate 224 in this embodiment can comprise a woven or non-woven carrier that serves as the physical structure for carrying the elongated heating elements 225, with the heating elements 225 being sewn to the carrier or substrate 24, for example using a zigzag or overlock stitch 227. The heating elements 225 can then be coated and/or the substrate 224 impregnated with a liquid protectant material 244 that encapsulates and covers the heating element application pattern so as to provide a layer of physical protection and insulation for the conductive heating elements 225. The liquid protectant material 144 can then be cured into the flexible insulation/protective layer 145 that envelops and protects the heating elements, and that together with the substrate 224 forms the inner glove layer 212. As described above, the heating elements 225 can form a heat-generating circuit within the finger sheath 236 when coupled to a source of operating voltage, and in one aspect can be substantially equally spaced about the circumference of the finger sheath 236.

Among other materials, the substrate 224 of the inner glove 112 can comprise any flexible textile fabric that is suitable for a heated garment application, and that heating elements 225 have been successfully attached to a variety of fabric carriers with comparable results. For example, heating elements 225 have been stitched onto non-woven materials, nylon taffetas, polyester fleeces and a variety of other materials for use in the manufacture of heated gloves. Some materials such as certain polyesters for example, may lend themselves to use as a fabric carrier more readily than others. This is due at least in part to the automated couching method of embroidery that can be used to integrate or attach the heating element 225 to the carrier 224, which may be more readily applied to a somewhat stiffer fabric. Also, some carrier materials have better thermal and/or electrical insulation properties than others, making them more desirable in the present application. As indicated in FIG. 8, for example, a single-sided polyester fleece or other, similar fabric materials that are flexible, easily manipulated by automated stitching equipment can be used for the carrier or substrate 224, and can include backing side 238 provide a more rigid and yet flexible surface for receiving the heating elements 225, and a face side 239 configured to be a good insulator against the loss of heat. However, it will be appreciated that some non-woven materials also may work well and that all suitable materials are included within the scope of the invention disclosed herein.

The outer glove layer may consist of leather, brushed micro-fleece, rugged nylon or any other durable fabric chosen for the environment in which the glove will be used. It is preferable that the outer glove layer comprise rugged nylon, which is water and chemical resistant and resistant to puncture and other damage that can jeopardize the inner substrate and heating elements. When using the silicone coated or impregnated substrate 224 to fabricate a glove, the inner glove layer 212 can be attached to the outer glove layer 214 by stitching 213 using automated embroidery and stitching equipment. In some embodiments, the inner glove layer in stitched to the outer glove layer using a single head stitching machine, while in other embodiments, a multi-head stitching machine also can be used.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. It therefore will be understood by those skilled in the art that while the present invention has been described above with reference to preferred embodiments, numerous variations, modifications, and additions can be made thereto without departing from the spirit and scope of the present invention as set forth in the following claims. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

1. A heated glove, comprising:
a glove body including a pair of matching body sections each formed from a textile material with a palm portion and a series of finger portions;
an elongated heating element formed from an electrically conductive material applied in a predetermined heating element application pattern and secured to an outer surface of each body section by a plurality of couching stitches;
wherein each body section of the pair of matching body sections has a substantially mirror image configuration and the heating elements are applied thereto in a substantially mirror image construction, such that the heating elements are substantially aligned in registration with each other as the body sections are joined together; and
a power source coupled to the heating elements to supply power thereto sufficient to cause the heating elements to produce a desired thermal output for heating the glove body.

2. The heated glove of claim 1, wherein a first free end of the heating element of a first one of the body sections is electrically connected with a first free end of the heating element of a second one of the body sections to form a circuit that extends across both body sections of the glove body.

3. The heated glove of claim 2, wherein a second free end of each heating element of each of the body sections is electrically connected to the power source for providing electrical power to the loop circuit.

4. The heated glove of claim 2, further comprising a bridge connector formed from a conductive material and coupled between the first free ends of the heating elements of the first and second body sections to electrically connect the heating elements across a seam defined between the first and second body sections.

5. The heated glove of claim 1, wherein the heating element of a first one of the body sections includes first and second ends that are aligned in end-to-end registration with first and second ends of heating element of a second one of the body sections along a seam joining the first and second body sections.

6. The heated glove of claim 1, wherein the glove body further comprises a thumb section formed separately from the body sections, the thumb section comprising a substrate and an additional heating element applied in a predetermined heating element application pattern and attached to the substrate by a plurality of couching stitches, wherein the thumb section is attached to the joined body sections with opposite ends of its heating element being electrically coupled with at least one heating element attached to at least one of the body sections.

7. The heated glove of claim 6, further comprising at least one bridge connector formed from a conductive material and coupled between the at least one heating element attached to at least one of the body sections and the additional heating element attached to the thumb section to form a circuit extending across the at least one body section and the thumb section of the glove body.

8. The heated glove of claim 1, wherein the heating element application pattern of the heating elements extends adjacent peripheral edges of the palm portions and along proximal and distal regions of the finger portions.

9. The heated glove of claim 1, further comprising a layer of insulation material applied to the outer surface of each body section to cover the heating elements.

10. The heated glove of claim 10, wherein the insulation material further comprises a liquid silicone applied to the outer surfaces and cured to form a flexible insulation layer encapsulating the heating elements.

11. The heated glove of claim 1, wherein each of the pair of matching body sections comprises a single-sided polyester fleece having a backing side and a face side, and wherein the heating element are applied to the backing side thereof.

12. A method of making a heated glove, comprising
laying down an elongate heating element of an electrically conductive material onto an outer surface of each of a series of body sections according to a predetermined heating element application pattern, and as the elongate heating is applied, attaching the heating element to the body sections with a series of couching stitches applied by a couching sewing application;
wherein corresponding ones of the body sections form a substantially mirror image sections, each with an elongate heating element applied in matching heating element application patterns;
joining first and second matching body sections to form a glove body having the heating elements attached thereto being substantially aligned in registration with each other; and
coupling free ends of each elongate heating element of each body section to a power transmission line for connection of the elongate heating elements to a power source.

13. The method of claim 12, wherein free ends of the heating element of the first and second matching body sections are aligned in end-to-end registration across a seam formed between the body sections.

14. The method of claim 12, further comprising electrically connecting a first free end of the heating element of the first body section with a first free end of the heating element of the second body section to form a circuit that extends along both body sections of the glove body.

15. The method of claim 14, further comprising:
applying a layer of insulation material to the outer surface of each body section; and
curing the insulation material to form a flexible insulation layer encapsulating the heating elements.
